(19) United States
(12) Patent Application Publication
(10) Pub. No.: US 2026/0127907 A1
(43) Pub. Date: May 7, 2026

(54) SYSTEM AND METHOD FOR DETECTING AND ASSOCIATING ELEMENTS IN AN IMAGE

(71) Applicant: Infrrd Inc, San Jose, CA (US)

(72) Inventors: Yogananda Ganesh Kashyap Ramaprasad, Bengaluru (IN); Srirama R Nakshathri, Bengaluru (IN); Pratyusha Rasamsetty, Cupertino, CA (US); Deepak Kumar, Bengaluru (IN)

(73) Assignee: Infrrd Inc, San Jose, CA (US)

(21) Appl. No.: 18/939,577

(22) Filed: Nov. 7, 2024

(51) Int. Cl. G06V 30/42; G06V 10/25; G06V 30/186; G06V 30/19; G06V 30/30; G06V 30/414

(52) U.S. Cl. CPC G06V 30/42; G06V 10/25; G06V 30/186; G06V 30/19013; G06V 30/414; G06V 30/30

(57) ABSTRACT

A system for detecting and associating elements in an image comprises detecting a plurality of text tokens in a query image. A first element is determined based on an entry point object list and the plurality of text tokens, wherein the entry point object list comprises of text objects or template shapes present in the query image. A plurality of region of interests (ROIs) around the first element in the query image are determined and a plurality of ROI images are created from the query image based on the plurality of ROIs. Determine a potential second element present in the plurality of ROI images. Generate a confidence score for each of the potential second elements. Filter the results based on the confidence score and a predetermined threshold to determine a second element. Subsequently, associate the second element with the first element as single component.

### BACKGROUND

### Field

The disclosed technology relates to image processing, specifically to the detection and association of elements within piping and instrumentation diagrams, to enhance the efficiency of retrieving relevant information for end users.

### Description of the Related Art

Piping and instrumentation diagrams (P&IDs) are widely used in engineering and industrial settings to represent the arrangement of piping, equipment, and instrumentation within a system. These diagrams are crucial for design, maintenance, and operational tasks. However, the complexity of these diagrams, which often include numerous interconnected elements (or components), may make it challenging for users to quickly locate and associate specific components.

The need to efficiently detect and relate elements in P&IDs is well recognized. Traditional methods involve manual inspection or the use of basic software tools that allow for limited search and identification of components. These approaches are often time-consuming and prone to error, particularly when dealing with large-scale or intricate diagrams where visual elements are dispersed across the document.

Existing techniques for element detection in P&IDs typically focus on textual elements using optical character recognition (OCR). While effective for text, these methods fall short when it comes to visual elements such as symbols or icons that represent various components. Furthermore, these methods do not adequately address the need to associate related elements that are spatially or contextually linked but positioned at different locations within the diagram.

In view of the foregoing, there is a growing demand for an improved system that can not only detect visual elements within P&IDs but also establish relationships between them. Such a system would enhance the usability of these diagrams, allowing for faster and more accurate retrieval of relevant information, thereby improving efficiency in engineering and industrial workflows.

### SUMMARY

A system for detecting and associating elements in an image is disclosed. The system comprising one or more processors may be configured to detect a plurality of text tokens in a query image. A first element may be determined based on an entry point object list and the plurality of text tokens, wherein the entry point object list may comprise of text objects or template shapes present in the query image. A plurality of region of interests (ROIs) may be determined around the first element in the query image and a plurality of ROI images may be created from the query image based on the plurality of ROIs. Further, a potential second element present in the plurality of ROI images may be determined and a confidence score for each of the potential second elements may be generated. Subsequently, the potential second element may be filtered based on the confidence score and a predetermined threshold to determine a second element, and the second element may be associated with the first element as single component.

### BRIEF DESCRIPTION OF DRAWINGS

The patent or application file contains at least one drawing executed in color. Copies of this patent or patent application publication with color drawing(s) will be provided by the Office upon request and payment of the necessary fee.

Embodiments are illustrated by way of example and not limitation in the figures of the accompanying drawings, in which like references indicate similar elements and in which:

FIG. 1A illustrates a system 100 enabling detection and association of elements present in piping and instrumentation diagrams (P&IDs), in accordance with an embodiment.

FIG. 1B illustrates a pipe mapping module 110, in accordance with an embodiment.

FIG. 2 illustrates a flowchart 200 for a method enabling the detection and association of elements within P&IDs, in accordance with an embodiment.

FIG. 3 illustrates an entry point object list 300, in accordance with an example embodiment.

FIG. 4A illustrates a flowchart 400A for identification of a first element based on a first text object among plurality of text objects (302, 304), in accordance with an embodiment.

FIG. 4B illustrates a flowchart 400B for identification of the first element based on a first template shape among plurality of template shapes (306, 308), in accordance with an embodiment.

FIG. 5 illustrates a flowchart 500 to perform visual object segmentation (VOS) on plurality of ROI images, in accordance with an embodiment.

FIG. 6 depicts a query image 106, in accordance with an example embodiment.

FIG. 7 depicts a portion 700 of the query image 106 with each instance of the detected text object 302, in accordance with the example embodiment.

FIG. 8 depicts a portion 800 of the query image 106 with each instance of the detected template shape 306, in accordance with the example embodiment.

FIG. 9A depicts an ROI image 900A created based on a small ROI created around the text object 302, in accordance with the example embodiment.

FIG. 9B depicts an ROI image 900B created based on a medium ROI created around the text object 302, in accordance with the example embodiment.

FIG. 9C depicts an ROI image 900C created based on a large ROI created around the text object 302, in accordance with the example embodiment.

FIG. 10A depicts an ROI image 1000A created based on a small ROI created around the template shape 306, in accordance with the example embodiment.

FIG. 10B depicts an ROI image 1000B created based on a medium ROI created around the template shape 306, in accordance with the example embodiment.

FIG. 10C depicts an ROI image 1000C created based on a large ROI created around the template shape 306, in accordance with the example embodiment.

FIG. 11 depicts a portion 1100 of a ROI image with detected potential second element around the text object 302, in accordance with the example embodiment.

FIG. 12 depicts a portion 1200 of a ROI image with detected potential second element around the template shape 306, in accordance with the example embodiment.

FIG. 13 is a block diagram illustrating a first data processing system 1300, in accordance with an embodiment.

FIG. 14 is a block diagram illustrating a server 1400, in accordance with an embodiment.

### DETAILED DESCRIPTION OF THE INVENTION

Embodiments of the disclosed technology enable the detection and association of elements within piping and instrumentation diagrams (P&IDs). These diagrams, which are critical for various engineering and industrial applications, contain numerous elements that represent components of a pipeline system. For effective use of P&IDs, it is essential to accurately identify and relate said elements. The disclosed technology facilitates this by detecting elements within a P&ID, associating them with relevant components, and enabling end users to retrieve and utilize this information more efficiently. Said process enhances the usability of P&IDs, thereby making it easier for users to retrieve, interpret, and apply the information contained within these diagrams.

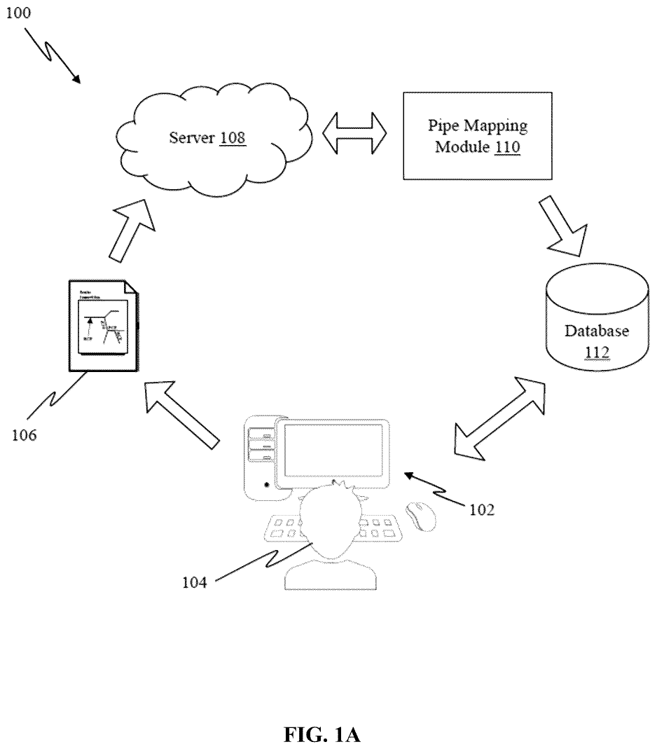

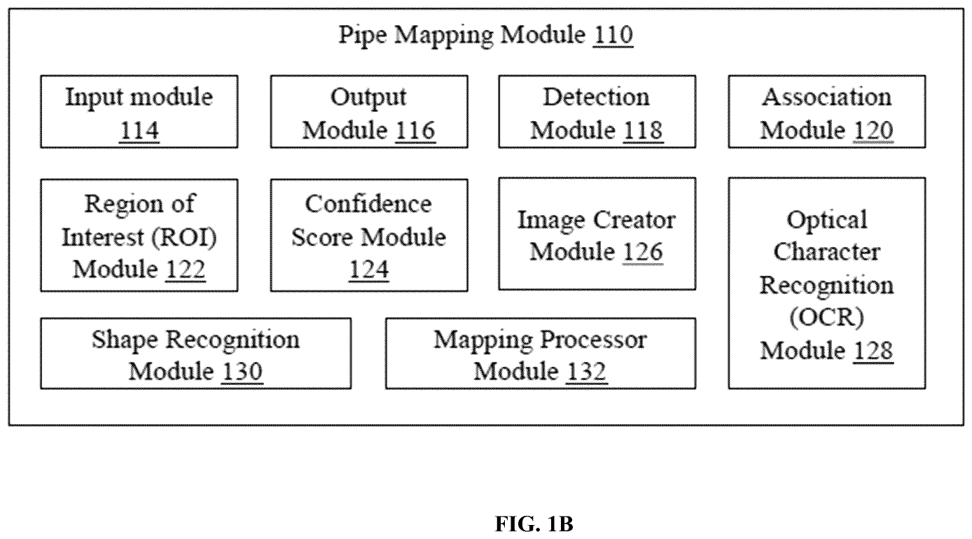

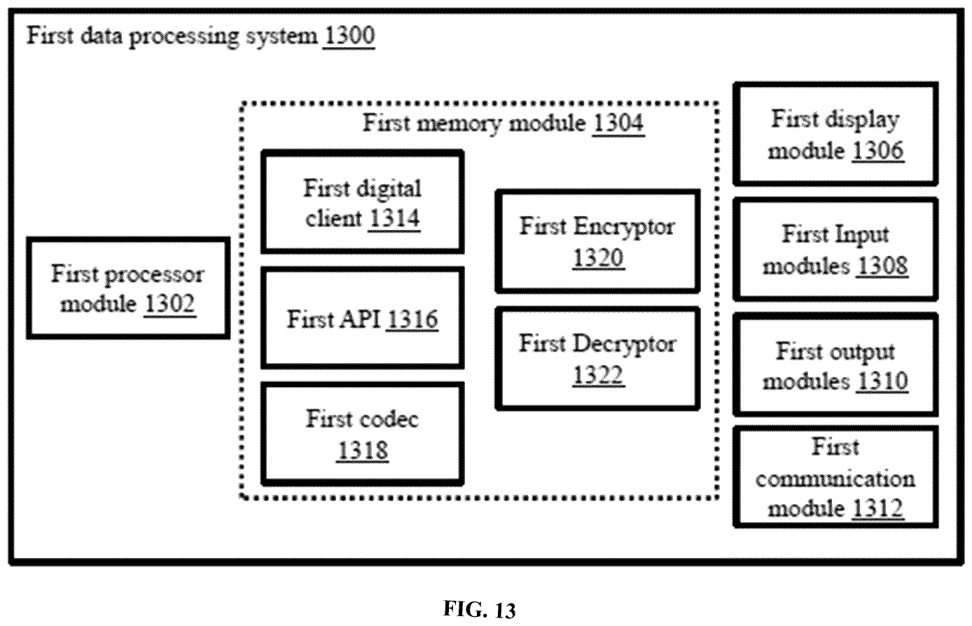

FIG. 1A illustrates a system 100 enabling the detection and association of elements present in P&IDs, in accordance with an embodiment. The system 100 may comprise of a data processing system 102, a user 104 associated with the data processing system 102, a query image 106, a server 108, a pipe mapping module 110, and a database 112. It may be noted that the pipe mapping module 110 may be a part of the data processing system 102 in some embodiments. An example configuration of the data processing system 102 is discussed later (refer FIG. 13).

In an embodiment, the pipe mapping module 110 may receive the query image 106 from the data processing system 102, wherein the pipe mapping module 110 upon processing the query image 106, may store detected elements (from the query image 106) and associations between them in the database 112. The user 104 may access the stored information from the database 112 via the data processing system 102.

In an embodiment, the query image 106 may be one image from the plurality of images present in the P&IDs.

In an alternate embodiment, plurality of pages present in the P&IDs may be converted into plurality of images, wherein query image 106 may be one among the plurality of images.

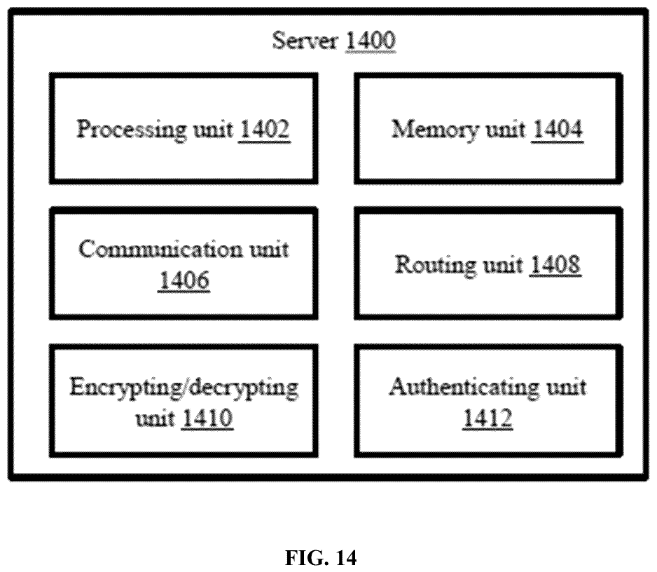

In an embodiment, the server 108 may be configured to enable communication among the data processing system 102, the pipe mapping module 110, and the database 112. An example configuration of the server 108 is discussed later (refer FIG. 14).

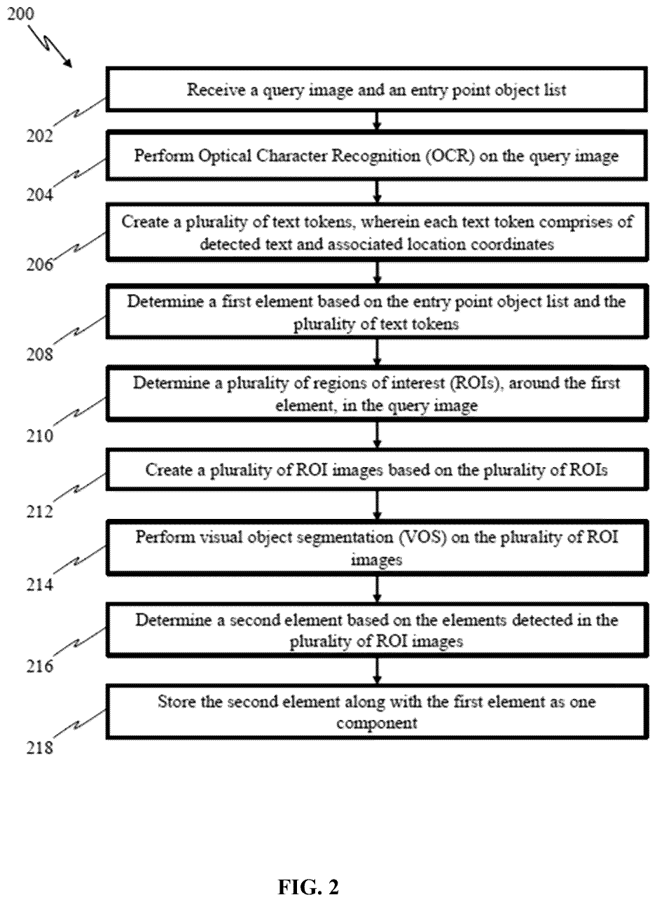

FIG. 1B illustrates the pipe mapping module 110, in accordance with an embodiment. The pipe mapping module 110 may comprise of an input module 114, an output module 116, a detection module 118, an association module 120, a region-of-interest (ROI) module 122, a confidence score module 124, an image creator module 126, an optical character recognition (OCR) module 128, a shape recognition module 130, and a mapping processor module 132. Functionality and association of each of the modules with each other is explained in greater detail in relation with the flowchart illustrated in FIG. 2 for easier understanding.

FIG. 2 illustrates a flowchart 200 for a method enabling the detection and association of elements within P&IDs, in accordance with an embodiment. The pipe mapping module 110 may receive the query image 106. The mapping processor module 132 may be configured to instruct the plurality of modules present in the pipe mapping module 110.

At step 202, the input module 114 may receive the query image 106 and an entry point object list 300.

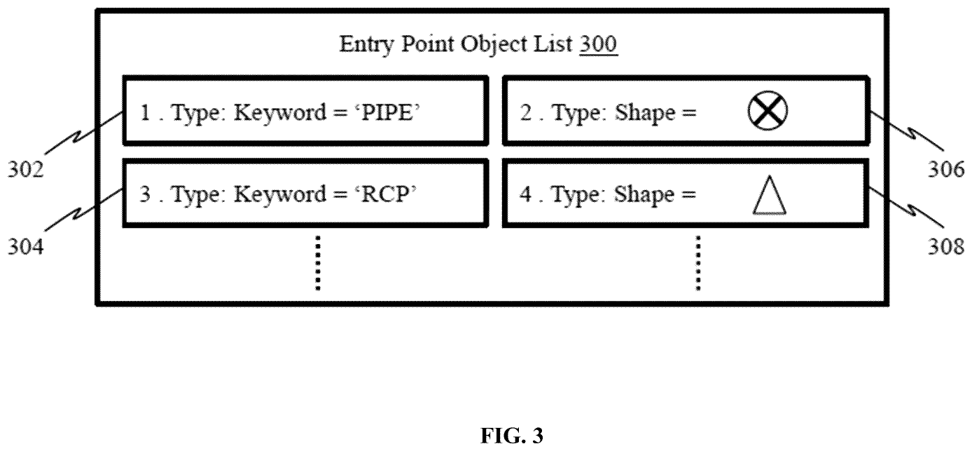

FIG. 3 illustrates the entry point object list 300, in accordance with an example embodiment. The entry point object list 300 may comprise of a plurality of text objects (302, 304) along with a plurality of template shapes (306, 308), wherein the plurality of text objects (302, 304) and the plurality of template shapes (306, 308) may be present in the query image 106.

It may be noted that an example embodiment illustrating output in reference to the flowcharts, wherever necessary, for easier understanding.

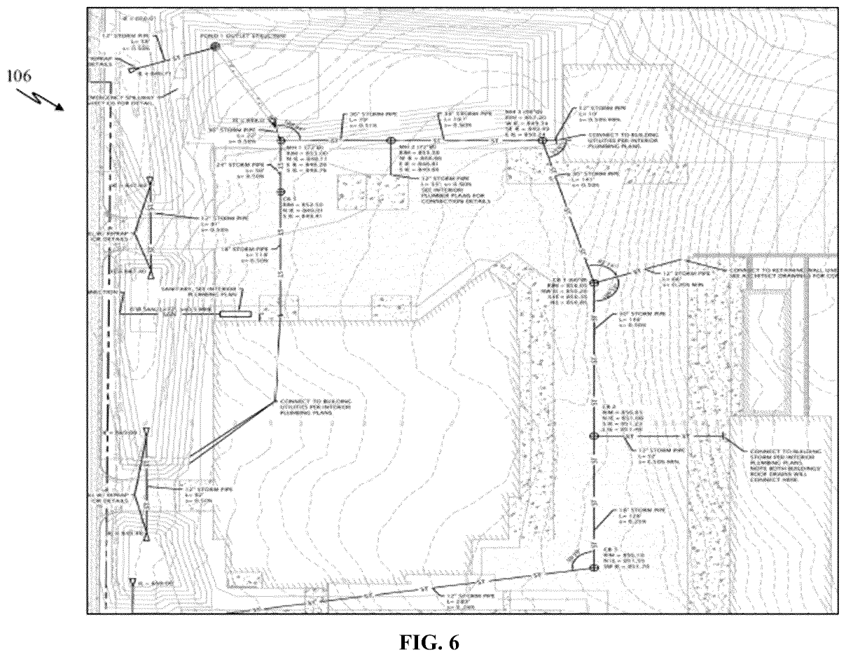

FIG. 6 depicts the query image 106, in accordance with an example embodiment. The depicted query image 106, which is a P&ID, may comprise of text such as, but not limited to, dimensions and/or pipe description, and shapes such as, but not limited to, pipes and/or connectors.

In the same example, the pipe mapping module 110 may receive the query image 106 and the entry point object list 300, wherein the entry point object list 300 may comprise of a text object 302 (“PIPE”) and a template shape 306.

At step 204, the OCR module 128 may be configured to perform OCR on the query image 106 to detect text and location coordinates associated with the detected text present in the query image 106.

At step 206, the mapping processor module 132 may create a plurality of text tokens, wherein the plurality of text tokens may comprise of detected text and the location coordinates associated with the detected text.

In an embodiment, a bounding box may be created around the detected text. The plurality of text tokens may comprise of the detected text and location coordinates associated with the bounding box encompassing the detected text.

At step 208, the detection module 118 may be configured to determine a first element based on the entry point object list 300 and the plurality of text tokens.

At step 210, the ROI module 122 may be configured to determine a plurality of regions of interest (ROIs) around the first element in the query image 106.

In an embodiment, at least three ROIs may be identified, wherein each ROI is of varying size (dimension). The ROIs are created based on the location of the first element.

At step 212, the image creator module 126 may create plurality of ROI images based on the plurality of ROIs, wherein each of the ROI images among the plurality ROI images may correspond to one ROI among the plurality of ROIs.

In an embodiment, the image creator module 126 may crop the query image 106 to create ROI images.

In another embodiment, the image creator module 126 may obtain a snapshot of a portion (region) of the query image 106 based on the plurality of ROIs.

At step 214, the mapping processor module 132 may be configured to perform visual object segmentation (VOS) for the plurality of ROI images. VOS has been explained in detail in later sections of the specification.

At step 216, the detection module 118 may determine a second element from the multiple plurality of ROI images based on the text objects and template shapes identified in the query image 106.

At step 218, the mapping processor module 132 may be configured to store said second element along with the first element as single component.

In an embodiment, following the step 218, the mapping processor module 132 may be configured to implement steps 210-218 again with the second element as the first element, and a third element is detected and stored as single component along with the second element. It may be noted that only the second element is considered to detect the third element i.e., elements around the second element are detected as potential third elements.

In an embodiment, the first element may be determined based on one text object among the plurality of text objects (302, 304) or based on one template shape among the plurality of template shapes (306, 308) from the entry point object list 300.

In an embodiment, the detection module 118 may comprise of a matching module, wherein the matching module may be configured to identify the first element based on a first text object among the plurality of text objects (302, 304).

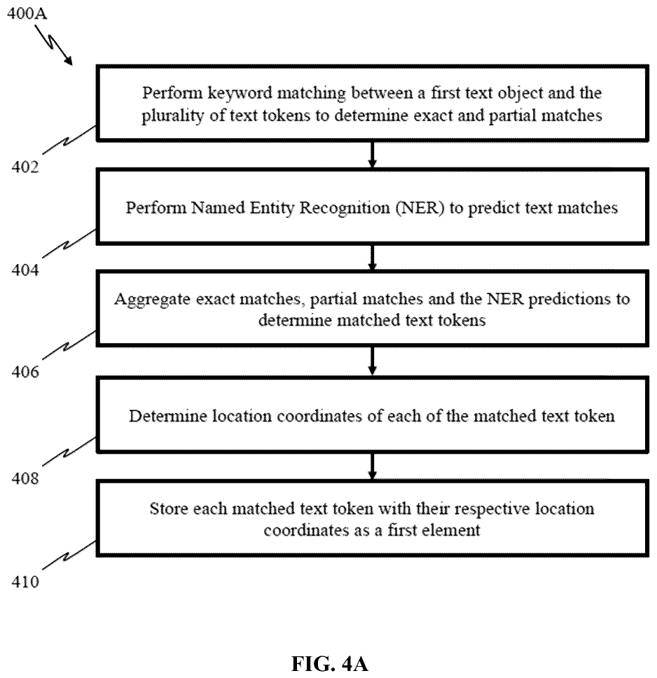

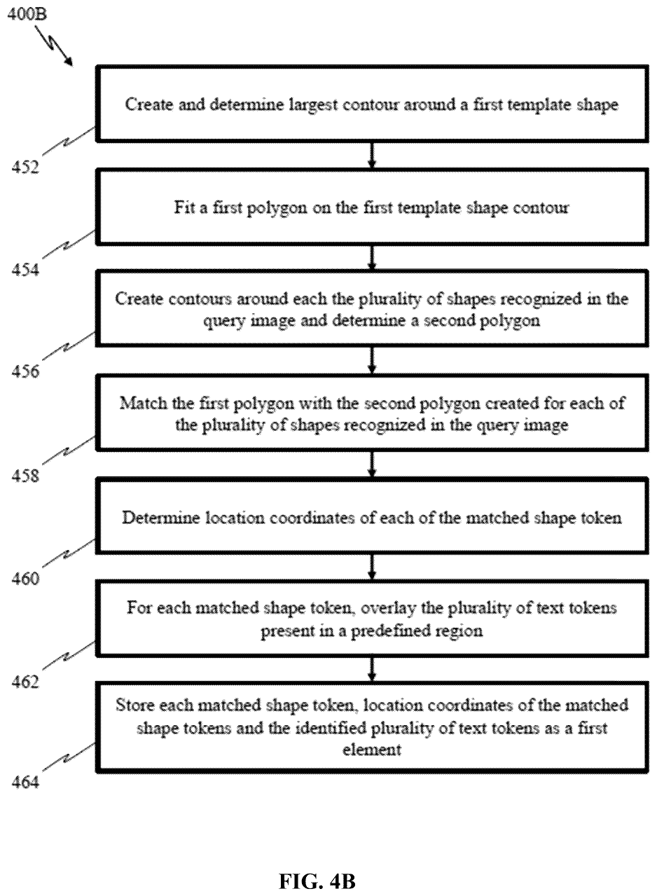

FIG. 4A illustrates a flowchart 400A for identification of the first element based on a first text object among the plurality of text objects (302, 304), in accordance with an embodiment. At step 402, the first text token may be matched with each of the plurality of text tokens to determine an exact match and a partial match.

At step 404, a named entity recognition (NER) may be performed to predict text matches.

In an embodiment, the first text token may be detected using, but not limited to, keyword matching, NER, fuzzy matching, Spacy NER, or by training a machine learning model.

At step 406, aggregate and determine matched text tokens based on the exact matches, the partial matches and the NER predictions.

At step 408, determine location coordinates of each of the matched text tokens.

In an embodiment, the received location coordinates may be associated with the bounding boxes encompassing the matched text tokens.

At step 410, store each of the matched text token and the associated location coordinates as the first element.

In an embodiment, if multiple instances of the matched text tokens are detected, the pipe mapping module 110 may be configured to store each instance of the matched text token along with the associated location coordinates.

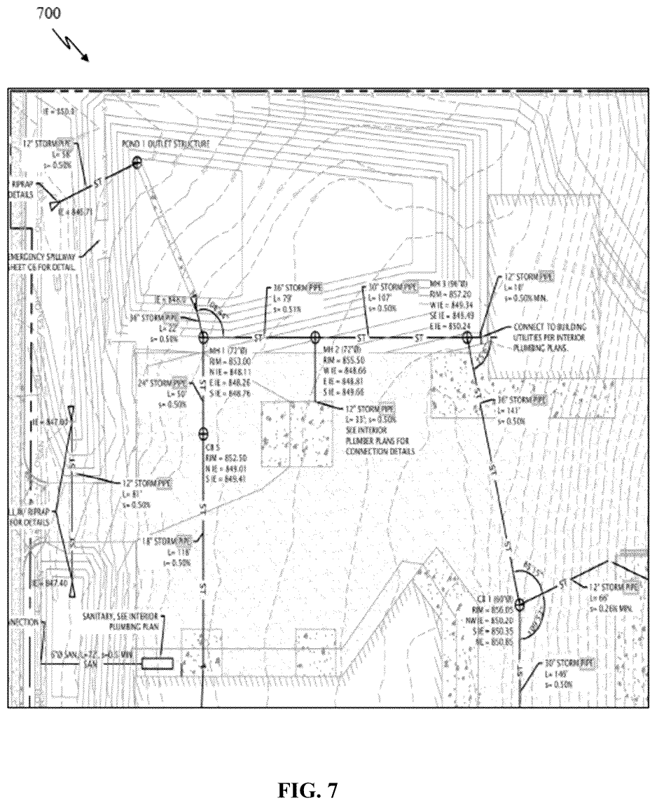

FIG. 7 depicts a portion 700 of the query image 106 with each instance of the detected text object 302, in accordance with the example embodiment. The portion 700 of the query image 106 depicts each instance of the text object 302 (“PIPE”) present within the query image 106, wherein each instance of the text object 302 is the first element i.e., multiple first elements are detected in the query image 106.

In an embodiment, the matching module may be configured to identify the first element based on a first template shape among the plurality of template shapes (306, 308).

FIG. 4B illustrates a flowchart 400B for identification of the first element based on a first template shape among the plurality of template shapes (306, 308), in accordance with an embodiment. At step 452, create and determine largest contour around the first template shape, wherein the first template shape may be one among the plurality of template shapes (306, 308).

In an embodiment, create contours on the first template shape. Multiple contours may be created on the first template shape, wherein the largest contour may be created around the first template shape i.e., largest contour may envelope the entire first template shape.

In an embodiment, the first template shape may be detected using, but not limited to, OPENCV contour detection, APPROXPOLYDP, template matching, and/or deep learning-based object recognition techniques such as a YOLO model.

Further in the embodiment, the first template shape may be detected using keypoint descriptor-based shape recognition techniques such as, but not limited to, Harris Corner detector, Scale-invariant feature transform (SIFT), Speeded-Up Robust Features (SURF), Binary robust independent elementary features (BRIEF), Features from accelerated segment test (FAST), and Oriented FAST and Rotated Brief (ORB).

At step 454, fit a first polygon on the first template shape contour. Further, first internal angles associated with the first polygon may be determined.

At step 456, identify and create contours around each of the plurality of shapes recognized in the query image. A second polygon may be determined based on the contours created. Further, second internal angles associated with the second polygon may be determined.

At step 458, match the first polygon with the second polygon created for each of the plurality of shapes recognized in the query image 106. Further, the first internal angles and the second internal angles may be compared to determine a match between the first polygon and the second polygon corresponding to each of the plurality of shapes.

In an embodiment, each first internal angle of the first polygon may be sequentially compared with the corresponding second internal angle of the second polygon. Comparison may be performed in a step-by-step manner, matching each angle to identify a correspondence between the first polygon and the second polygon.

In an embodiment, an error value may be calculated for each angle comparison. A match may be confirmed if the error value between the corresponding angles is less than a predefined threshold, ensuring that the first polygon and the second polygons are sufficiently similar.

In an embodiment, the pipe mapping module 110 may be configured to determine a scale associated with the query image and estimate dimensions of the plurality of shapes based on the location coordinates corresponding to each matched template shape and the scale of the query image.

At step 460, upon identifying matched shape tokens, determine location coordinates associated with each of the matched shape tokens.

At step 462, retrieve location coordinates associated with each of the plurality of text tokens present in a predefined region as that of the matched shape tokens. Further, overlay the plurality of text tokens identified within the predefined region.

In an embodiment, the predefined region may encompass the entire matched shape token. Further, the matched shape token may comprise of at least one text token among the plurality of text tokens identified by the OCR module 128.

In another embodiment, the predefined region may be of same size as that of the largest contour created around the first template shape.

At step 464, store each of the matched shape tokens, the location coordinates associated with the matched shape token, and the identified plurality of text tokens as the first element.

In an embodiment, if multiple instances of the matched shape tokens are detected, the pipe mapping module 110 may be configured to store each instance of the matched shape token along with the associated location coordinates.

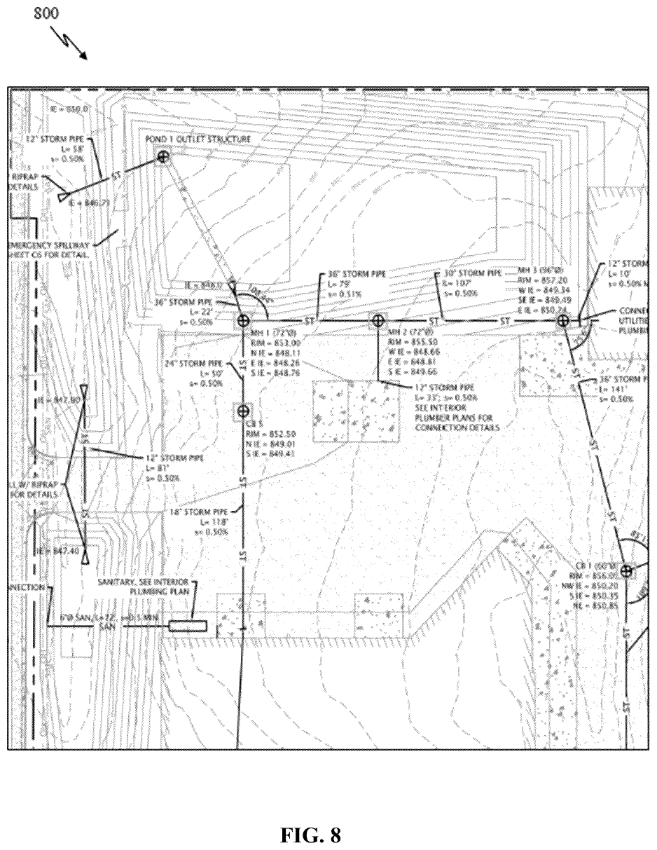

FIG. 8 depicts a portion 800 of the query image 106 with each instance of the detected template shape 306, in accordance with an embodiment. The portion 800 of the query image 106 depicts each instance of the template shape 306 present within the query image 106, wherein each instance of the template shape 306 is the first element.

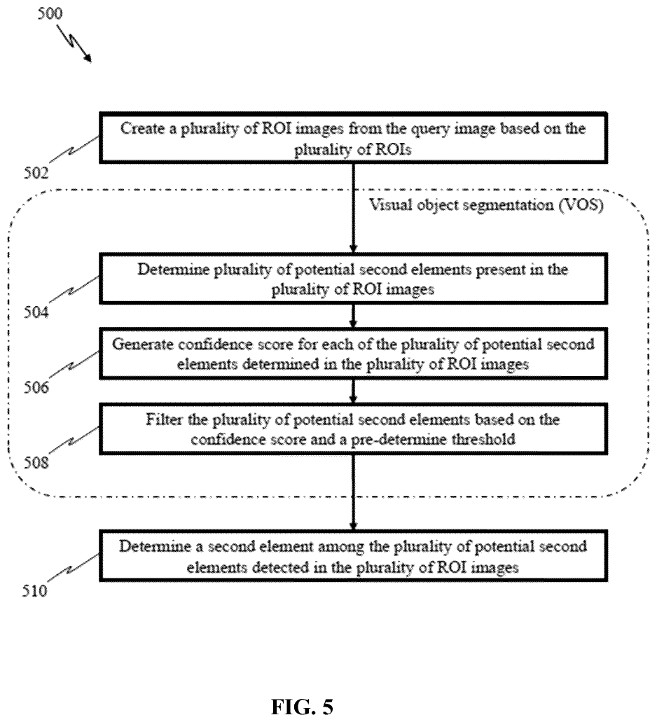

FIG. 5 illustrates a flowchart 500 to perform visual object segmentation (VOS) on the plurality of ROI images, in accordance with an embodiment. At step 502, plurality of ROI images, as an example, at least three ROI images corresponding to three different ROIs may be created.

In an embodiment, the mapping processor module 132 may be configured to retrieve the plurality of text tokens and the plurality of shapes recognized in the plurality of ROI images based on the location coordinates of the created ROI images.

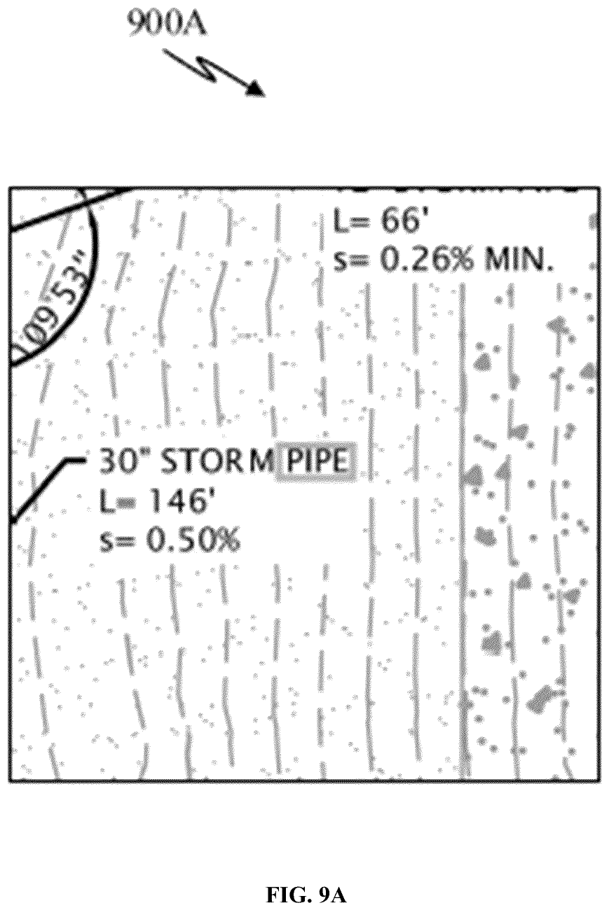

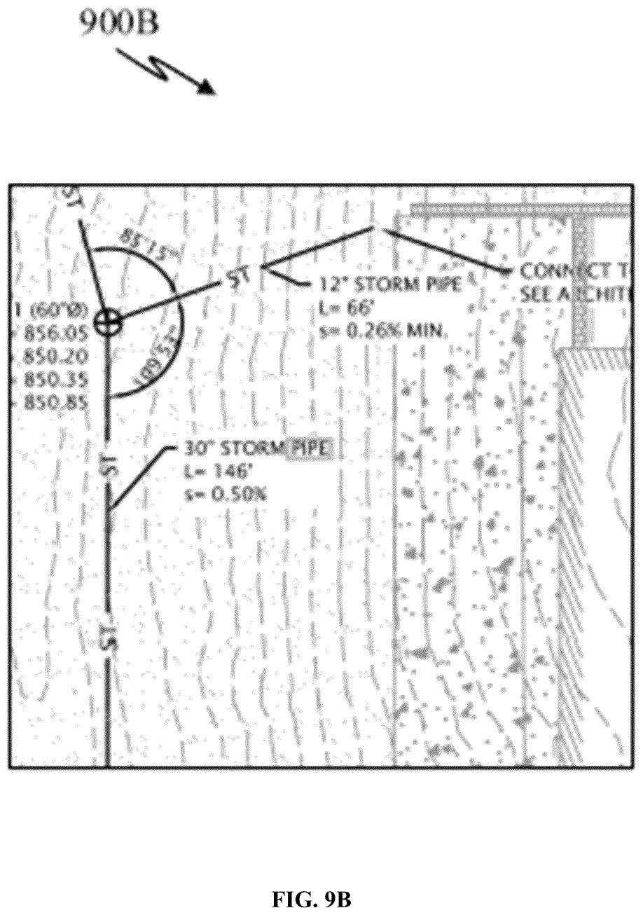

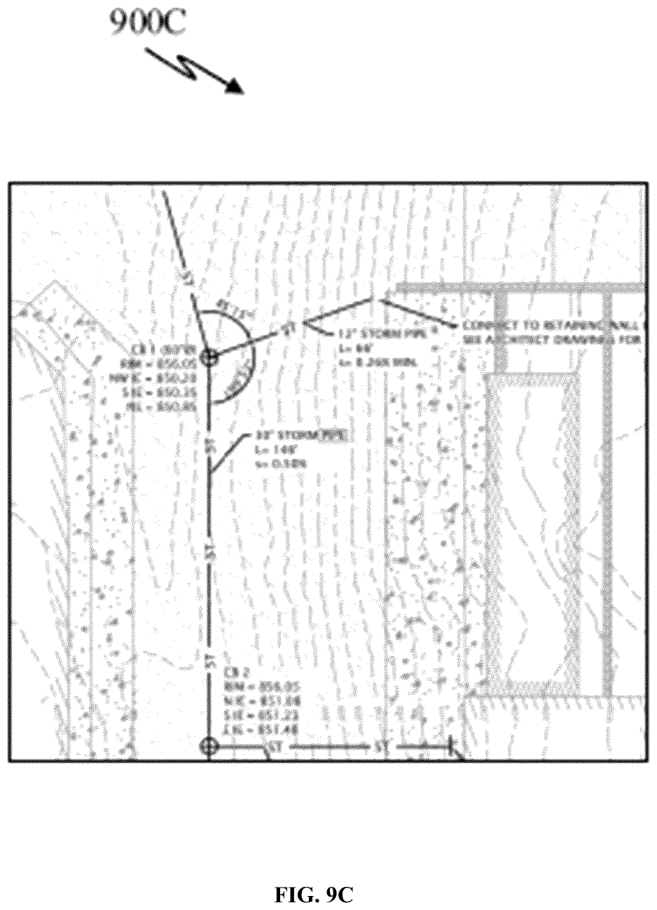

FIGS. 9A-9C depict plurality of ROI images (900A, 900B, 900C) created based on the plurality of ROIs created around the text object 302, in accordance with the example embodiment. Notably, the ROI for ROI image 900A is smaller than both ROI images 900B and 900C. ROI for ROI image 900B is larger than ROI image 900A but smaller than ROI image 900C. ROI for ROI image 900C is the largest of the three and may include more elements than ROI images 900A and 900B.

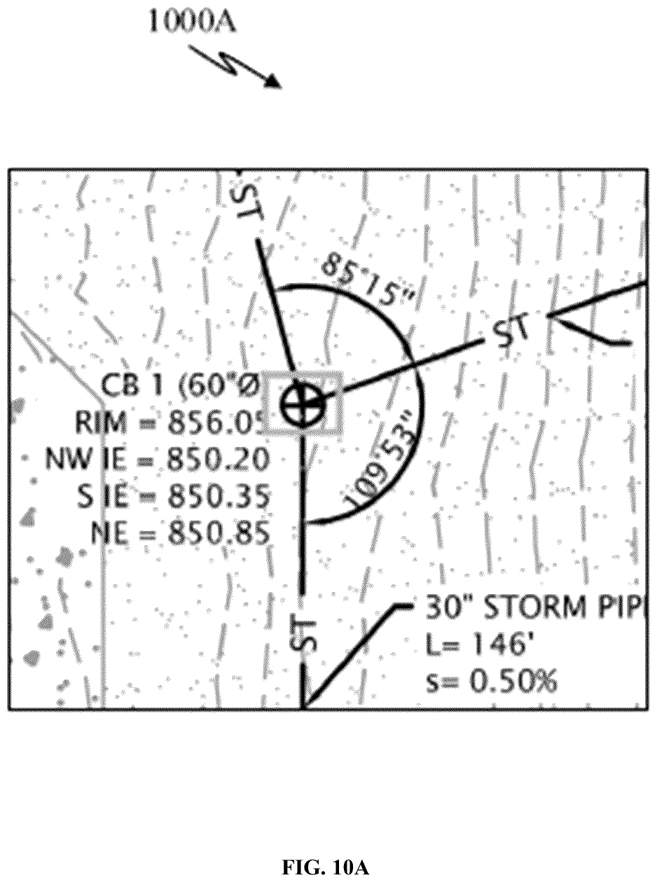

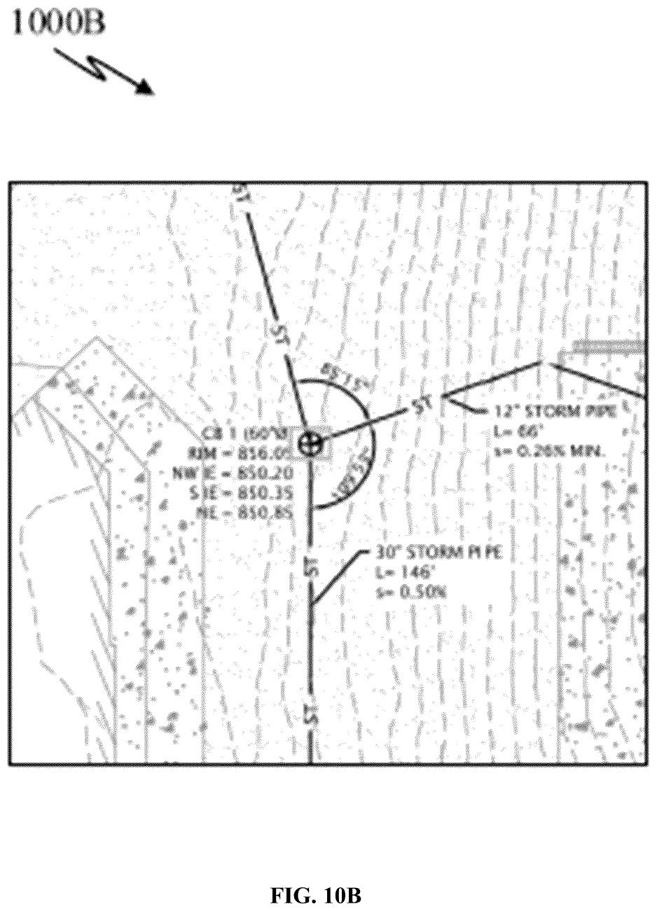

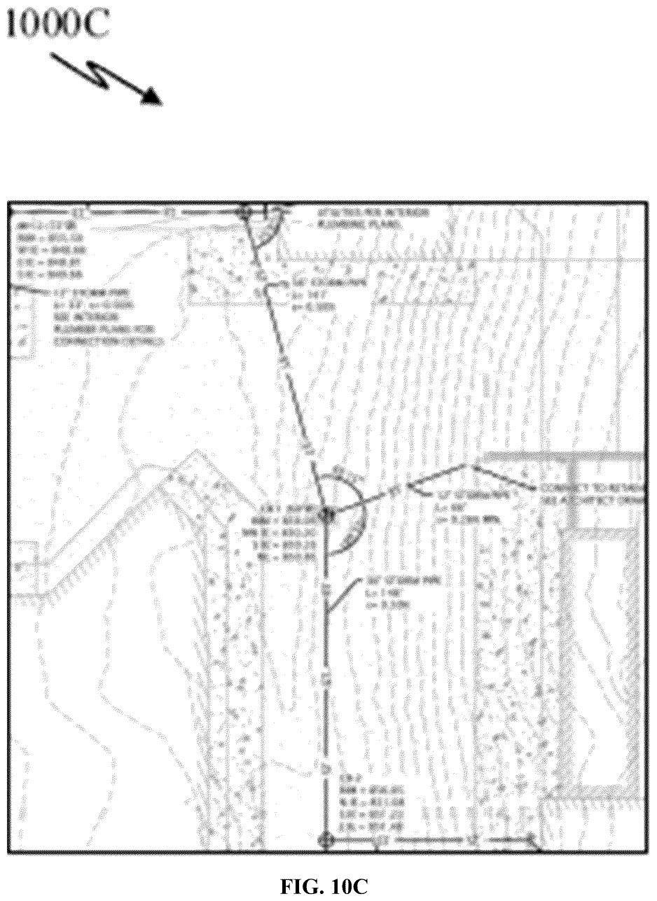

Similarly, FIGS. 10A-10C depict plurality of ROI images (1000A, 1000B, 1000C) created based on the plurality of ROIs created around the template shape 306, in accordance with the example embodiment. Notably, the ROI for ROI image 1000A is smaller than both ROI images 1000B and 1000C. ROI for ROI image 1000B is larger than ROI image 1000A but smaller than ROI image 1000C. ROI for ROI image 1000C is the largest of the three and may include more elements than ROI images 1000A and 1000B.

At step 504, the detection module 118 may be configured to determine a plurality of potential second elements present within each of the plurality of ROI images.

In an embodiment, the detection module 118 may be configured retrieve text tokens among the plurality of text tokens present within each of the plurality of ROI images.

In an embodiment, the detection module 118 may be configured to perform shape recognition to determine the plurality of shapes present within each of the plurality of ROI images.

In an embodiment, the recognition of potential second elements may be performed using machine learning (ML) algorithms such as, but not limited to, computer vision (CV) algorithms, natural language processing (NLP) algorithms, or deep learning (DL) algorithms.

Further, in the embodiment, the machine learning models may be trained using conventional machine learning approaches such as, but not limited to, k-nearest neighbour (KNN), decision tree (DT), random forest classifier (RFC), xg-boost classifier (XGB), artificial neural network (ANN), recursive neural network (RNN), long-short term memory (LSTM), support vector machine (SVM), naive Bayes (NB) or deep learning approaches such as, Convolutional neural network (CNN), and ResNet, Transformers.

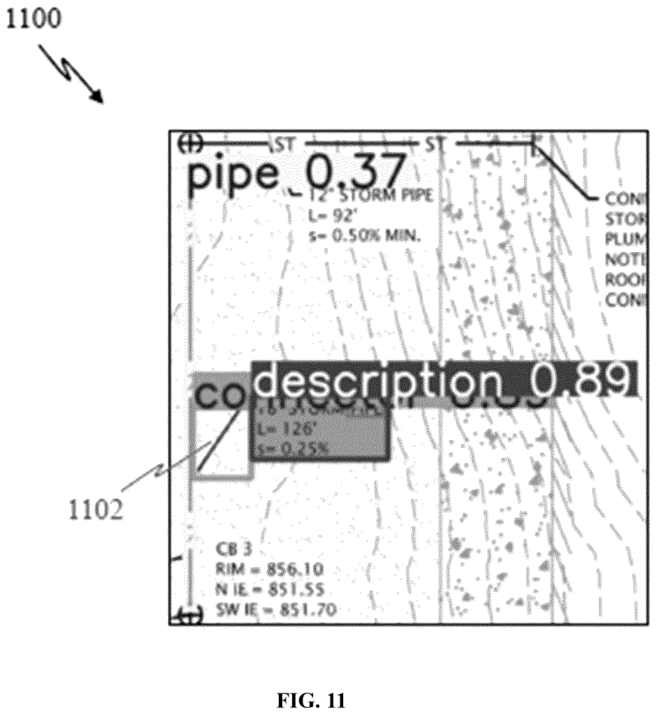

FIG. 11 depicts a portion 1100 of a ROI image with detected potential second element around the text object 302, in accordance with the example embodiment. The image 1100 depicts a pipe connector 1202 detected in the same ROI image in which the text object 302 is present.

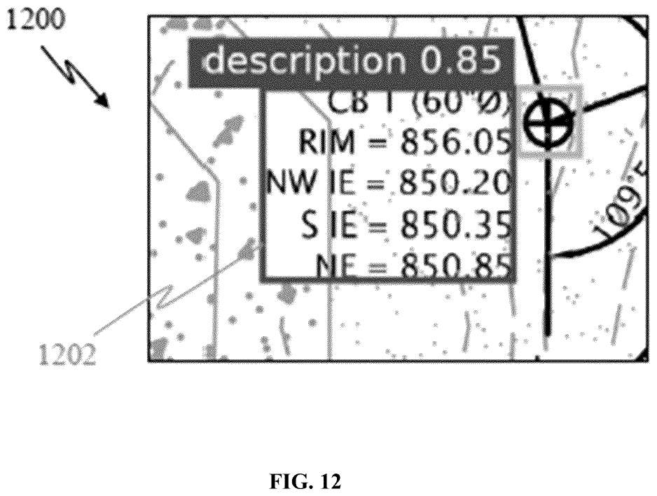

FIG. 12 depicts a portion 1200 of a ROI image with detected potential second element around the template shape 306, in accordance with the example embodiment. The image 1200 depicts a text object 1202 detected in the same ROI image in which the template shape 306 is present.

At step 506, the confidence score module 124 may be configured to generate a confidence score for each of the plurality of potential second elements.

In an embodiment, the confidence score may be generated based on the proximity of the potential second elements from the first element.

In an embodiment, a region of overlap may be determined and further the region of overlap may be considered during the confidence score generation.

At step 508, the confidence score module 124 may be configured to filter from the plurality of potential second elements based on a predetermined threshold and the confidence score associated with each potential second element.

At step 510, the mapping processor module 132 may be configured to determine a second element from the filtered plurality of potential second elements.

It may be noted that, multiple second elements may be determined, wherein each second element may be associated with the first element as single component.

In an embodiment, upon the determination of the second element, the second element may be considered as a first element, and the steps 208-218 described above may be repeated to determine a third element and further stored as single component along with the second element.

The processes described above is described as a sequence of steps, this was done solely for the sake of illustration. Accordingly, it is contemplated that some steps may be added, some steps may be omitted, the order of the steps may be re-arranged, or some steps may be performed simultaneously.

The methods described above may be implemented by a data processing system that performs the steps through executing instructions stored on a non-transitory computer-readable medium.

The example embodiments described herein may be implemented in an operating environment comprising software installed on a computer, in hardware, or in a combination of software and hardware.

Moving on, we now explain an example configuration of the data processing system associated with the author and end user. FIG. 13 is a block diagram illustrating a first data processing system 1300, in accordance with an embodiment. The first data processing system 1300 may comprise a first processor module 1302, a first memory module 1304, a first display module 1306, first input modules 1308, first output modules 1310 and a first communication module 1312.

The first processor module 1302 may be implemented in the form of one or more processors and may be implemented as appropriate in hardware, computer-executable instructions, firmware, or combinations thereof. Computer-executable instruction or firmware implementations of the first processor module 1302 may include computer-executable or machine-executable instructions written in any suitable programming language to perform the various functions described.

The first memory module 1304 may include a permanent memory such as hard disk drive, may be configured to store data, and executable program instructions that are implemented by the processor module. The first memory module 1304 may be implemented in the form of a primary and a secondary memory. The first memory module 1304 may store additional data and program instructions that are loadable and executable on the first processor module 1302, as well as data generated during the execution of these programs. Further, the first memory module 1304 may be volatile memory, such as random-access memory and/or a disk drive, or non-volatile memory. The first memory module 1304 may comprise of removable memory such as a Compact Flash card, Memory Stick, Smart Media, Multimedia Card, Secure Digital memory, or any other memory storage that exists currently or may exist in the future.

In an embodiment, the first memory module 1304 may further comprise a first digital client 1314, a first Application Programming Interface (API) 1316, a first codec 1318, a first encryptor 1320 and a first decryptor 1322. The first digital client 1314 may be a web browser or a software application. The first codec 1318 may include computer-executable or machine-executable instructions written in any suitable programming language to perform compress outgoing data and decompress incoming data. The first encryptor 1320 may encrypt the data being sent and the first decryptor 1322 may decrypt the incoming data.

The first display module 1306 may display an image, a video, or data to a user. For example, the first display module 1306 may include a panel, and the panel may be an LCD, LED or an AM-OLED.

The first input modules 1308 may provide an interface for input devices such as keypad, touch screen, mouse and stylus among other input devices. In an embodiment, the first input modules 1308 includes a scanner, a barcode reader, a camera and/or a microphone.

The first output modules 1310 may provide an interface for output devices such as display screen, speakers, printer and haptic feedback devices, among other output devices.

The first communication module 1312 may be used by the first data processing system 1300 to communicate with the server 1400. The first communication module 1312, as an example, may be a GPRS module, or other modules that enable wireless communication.

Further, we now explain an example configuration of the server 1400 enabling the data processing systems to establish communication. FIG. 14 is a block diagram illustrating a server 1400, in accordance with an embodiment. The server 1400 may comprise a processing unit 1402, a memory unit 1404, a communication unit 1406, a routing unit 1408, an encrypting/decrypting unit 1410 and an authenticating unit 1412.

The processing unit 1402 may be implemented in the form of one or more processors and may be implemented as appropriate in hardware, computer-executable instructions, firmware, or combinations thereof. Computer-executable instruction or firmware implementations of the processing unit 1402 may include computer-executable or machine-executable instructions written in any suitable programming language to perform the various functions described.

The memory unit 1404 may include a permanent memory such as hard disk drive, may be configured to store data, and executable program instructions that are implemented by the processor module.

The communication unit 1406 may be used by the server 1400 to communicate with the first data processing system 1300. The communication unit 1406, as an example, may be a GPRS module, or other modules that enable wireless communication.

The routing unit 1408 may enable identification of data processing systems to which the data must be transmitted.

The encrypting/decrypting unit 1410 may encrypt the incoming data from the first data processing system 1300 and decrypt the outgoing data from the server 1400.

The authenticating unit 1412 may authenticate the first data processing system 1300 before establishing a connection.

The foregoing description refers to the various steps being carried out by a data processing system. Such a data processing system may be a stand-alone data processing system or a network of data processing system(s) and server.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

The detailed description includes references to the accompanying drawings, which form a part of the detailed description. The drawings show illustrations in accordance with example embodiments. These example embodiments, which may be herein also referred to as “examples” are described in enough detail to enable those skilled in the art to practice the present subject matter. However, it may be apparent to one with ordinary skill in the art, that the present invention may be practised without these specific details. In other instances, well-known methods, procedures and components have not been described in detail so as not to unnecessarily obscure aspects of the embodiments. The embodiments can be combined, other embodiments can be utilized, or structural, logical, and design changes can be made without departing from the scope of the claims. The detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

What is claimed is:

1. A system for detecting and associating elements in an image, the system comprising one or more processors configured to:
detect a plurality of text tokens in a query image;
determine a first element based on an entry point object list and the plurality of text tokens, wherein the entry point object list comprises of text objects or template shapes present in the query image;
determine a plurality of region of interests (ROIs) around the first element in the query image;
create a plurality of ROI images from the query image based on the plurality of ROIs;
determine potential second element present in the plurality of ROI images;
generate a confidence score for each of the potential second elements;
filter the potential second elements based on the confidence score and a predetermined threshold to determine a second element; and
associate the second element with the first element as single component.

2. The system according to claim 1, wherein the one or more processors are configured to perform optical character recognition (OCR) on the query image to detect the plurality of text tokens, wherein the plurality of text tokens comprises of detected text and associated location coordinates.

3. The system according to claim 2, wherein the one or more processors are configured to:
perform text matching between a first text from the entry point object list and the plurality of text tokens to determine partial matches and exact matches;
perform named entity recognition (NER) to obtain NER predictions;
aggregate and determine matched text tokens based on the exact matches, the partial matches and the NER predictions;
determine location coordinates of each of the matched text tokens; and
store, as a first element, each matched text token with associated location coordinates.

4. The system according to claim 3, wherein the one or more processors are configured to:
create a bounding box around the detected text;
store the location coordinates of the detected text along with location coordinates associated with the bounding box; and
perform NER based on the location coordinates associated with the bounding box.

5. The system according to claim 1, wherein the one or more processors are configured to:
generate a contour around a first template shape from the entry point object list;
fit a first polygon on the generated contour;
identify template shapes in the query image and generate contour around the identified template shape;
determine a second polygon based on the generated contour around the identified template shape;
match the first polygon with the second polygon, wherein the second polygon is associated with the identified template shape;
determine location coordinates corresponding to each matched template shape;
overlay text tokens from the plurality of text tokens present within a predefined region based on the location coordinates corresponding to each matched template shape; and
store the matched template shape, corresponding location coordinates, and the overlaid text tokens as a first element.

6. The system according to claim 5, wherein the one or more processors are configured to:
determine internal angles of the first polygon;
determine internal angles of the second polygon associated with each template shape; and
match the multiple template shapes with the first template shape based on the internal angles of the first polygon and the internal angles of the second polygon.

7. The system according to claim 6, wherein the one or more processors are configured to:
determine a scale associated with the query image; and
estimate dimensions of the plurality of shapes based on the location coordinates corresponding to each matched template shape and the determined scale associated with the query image.

8. The system according to claim 1, wherein the one or more processors are configured to determine at least two regions of interest (ROIs) of varying sizes around the first element in the query image.

9. The system according to claim 1, wherein the one or more processors are configured to generate the confidence score based on proximity of the potential second element and the first element.

10. The system according to claim 1, wherein the one or more processors are configured to determine atleast one second element from the plurality of potential second elements, wherein the confidence score associated with the second element is higher than the predetermined threshold.

11. A method for detecting and associating elements in an image, the method executed by one or more processors comprising the steps of:
detecting, by an optical character recognition (OCR) module, a plurality of text tokens in a query image;
determining, by a detection module, a first element based on an entry point object list and the plurality of text tokens, wherein the entry point object list comprises of text objects or template shapes present in the query image;
determining, by a region of interest (ROI) module, a plurality of region of interests (ROIs) around the first element in the query image;
creating, by an image creator module, a plurality of ROI images from the query image based on the plurality of ROIs;
determining, by the detection module, a potential second element present in the plurality of ROI images;
generating, by a confidence score module, a confidence score for each of the potential second element;
filtering, by the confidence score module, the potential second element based on the confidence score and a predetermined threshold to determine a second element; and
associating, by an association module, the determined second element with the first element as a single component.

12. The method according to claim 11, wherein the detection module may be configured to execute the steps of:
performing text matching between a first text from the entry point object list and the plurality of text tokens to determine partial matches and exact matches;
performing named entity recognition (NER) to obtain NER predictions;
aggregating and determining matched text tokens based on the exact matches, the partial matches and the NER predictions;
determining location coordinates of each of the matched text tokens; and
storing each matched text token with associated location coordinates as a first element.

13. The method according to claim 11, wherein the detection module may be configured to execute the steps of:
generating a contour around a first template shape from the entry point object list;
fitting a first polygon on the generated contour;
identifying template shapes in the query image and generating contours around the identified template shapes;
determining a second polygon based on the generated contours around each of the identified template shapes;
matching the first polygon with the second polygon, wherein the second polygon is associated with the identified template shape;
determining location coordinates corresponding to each matched template shape;
overlaying text tokens from the plurality of text tokens present within a predefined region based on the location coordinates corresponding to each matched template shape; and
storing the matched template, corresponding location coordinates, and the overlaid text tokens as a first element.
